(19) United States
(12) Patent Application Publication
(10) Pub. No.: US 2026/0219624 A1
(43) Pub. Date: Jul. 30, 2026

(54) RECORDING MEDIUM ACCOMMODATING DEVICE AND IMAGE FORMING APPARATUS

(71) Applicant: FUJIFILM Business Innovation Corp., Tokyo (JP)

(72) Inventor: Yoshiki KIMURA, Kanagawa (JP)

(73) Assignee: FUJIFILM Business Innovation Corp., Tokyo (JP)

(21) Appl. No.: 19/298,215

(22) Filed: Aug. 13, 2025

(30) Foreign Application Priority Data
Jan. 29, 2025 (JP) 2025-013116

(51) Int. Cl. G03G 15/00

(52) U.S. Cl. CPC G03G 15/6502

(57) ABSTRACT

A recording medium accommodating device includes an opposing member that is provided to be movable in an advancing and retracting manner with respect to a side portion of a recording medium to be loaded and that is disposed at a position facing the side portion, an acquisition unit that acquires information regarding the recording medium to be loaded, the acquisition unit being supported by the opposing member and moving in accordance with advancement and retraction of the opposing member, and a support portion that is disposed below a movement path of the acquisition unit and that is provided to be movable in an up-down direction and supports a part of the recording medium to be loaded from below, in which the support portion is configured such that a length of the support portion in a movement direction of the acquisition unit is changeable.

### CROSS-REFERENCE TO RELATED APPLICATIONS

This application is based on and claims priority under 35 USC 119 from Japanese Patent Application No. 2025-013116 filed Jan. 29, 2025.

### BACKGROUND

### (i) Technical Field

The present disclosure relates to a recording medium accommodating device and an image forming apparatus.

### (ii) Related Art

JP2015-24868A discloses a sheet supply device including a blowing unit that blows air onto a sheet bundle, and a conveying unit that adsorbs an uppermost sheet floated by the blowing unit and that conveys the uppermost sheet in a conveyance direction.

### SUMMARY

In a recording medium accommodating device that accommodates recording media, the recording media may be supported from below by using a support portion, and an acquisition unit that acquires information regarding the recording media, such as a camera, may be provided.

In addition, in the recording medium accommodating device, the support portion may be raised as the number of recording media to be loaded decreases. In this case, in a configuration in which the support portion is positioned directly below the acquisition unit, the acquisition unit and the rising support portion may interfere with each other.

Aspects of non-limiting embodiments of the present disclosure relate to a recording medium accommodating device and an image forming apparatus that prevent interference between an acquisition unit that acquires information regarding a recording medium to be loaded, and a support portion that is provided to be movable in an up-down direction and that supports the recording medium from below.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a recording medium accommodating device including: an opposing member that is provided to be movable in an advancing and retracting manner with respect to a side portion of a recording medium to be loaded and that is disposed at a position facing the side portion; an acquisition unit that acquires information regarding the recording medium to be loaded, the acquisition unit being supported by the opposing member and moving in accordance with advancement and retraction of the opposing member; and a support portion that is disposed below a movement path of the acquisition unit and that is provided to be movable in an up-down direction and supports a part of the recording medium to be loaded from below, in which the support portion is configured such that a length of the support portion in a movement direction of the acquisition unit is changeable.

### BRIEF DESCRIPTION OF THE DRAWINGS

Exemplary embodiment(s) of the present invention will be described in detail based on the following figures, wherein:

FIG. 1 is a view showing an image forming apparatus;

FIG. 2 is a diagram showing an example of a hardware configuration of a control unit;

FIG. 3 is a perspective view of a paper accommodating device in a case where the paper accommodating device is viewed from a front side of the image forming apparatus;

FIG. 4 is a view of the paper accommodating device as viewed in a direction indicated by an arrow IV in FIG. 3;

FIG. 5 is a cross-sectional view of the paper accommodating device taken along line V-V of FIG. 4;

FIG. 6 is a view showing a comparative example of the paper accommodating device; and

FIG. 7 is a view showing another configuration example of the paper accommodating device, in which a single component member is provided.

### DETAILED DESCRIPTION

Hereinafter, exemplary embodiments of the present disclosure will be described with reference to the accompanying drawings.

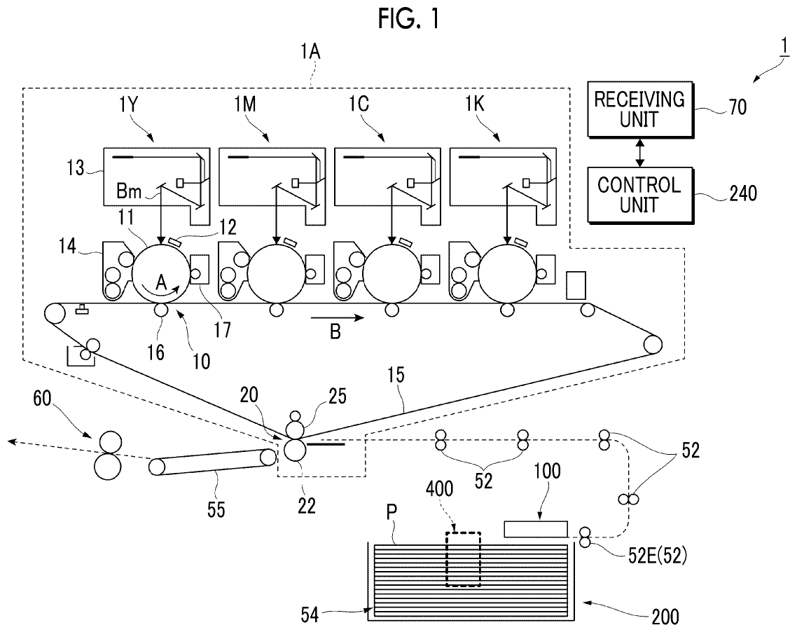

FIG. 1 is a view showing an image forming apparatus 1 according to the present exemplary embodiment.

The image forming apparatus 1 shown in FIG. 1 is an image forming apparatus of an intermediate transfer type called a tandem type. The image forming apparatus 1 is provided with a paper accommodating device 200 which is an example of a recording medium accommodating device. Paper P, which is an example of a recording medium, is accommodated in the paper accommodating device 200.

Additionally, the image forming apparatus 1 is provided with an image forming section 1A. The image forming section 1A forms an image on the paper P fed out from the paper accommodating device 200.

The image forming section 1A is provided with a plurality of image forming units 1Y, 1M, 1C, and 1K. Each of the plurality of image forming units 1Y, 1M, 1C, and 1K forms a toner image of a corresponding color component by using an electrophotographic method.

Additionally, the image forming section 1A is provided with a primary transfer unit 10. The toner images of respective colors formed by the image forming units 1Y, 1M, 1C, and 1K are transferred onto an intermediate transfer belt 15 by the primary transfer unit 10.

Further, the image forming section 1A is provided with a secondary transfer unit 20. The toner images transferred onto the intermediate transfer belt 15 are transferred onto the paper P by the secondary transfer unit 20.

In addition, the image forming apparatus 1 is provided with a fixing device 60 that fixes the toner image secondarily transferred onto the paper P to the paper P.

The image forming apparatus 1 is further provided with a control unit 240 that controls an operation of each unit of the image forming apparatus 1. Additionally, the image forming apparatus 1 is provided with a receiving unit 70 that receives information input by a user.

The receiving unit 70 is configured, for example, by a touch panel. The receiving unit 70 has, in addition to a reception function of receiving information from the user, a display function of displaying the information.

A device for implementing the reception function and a device for implementing the display function may be individually provided.

In the present exemplary embodiment, an image forming apparatus 1 capable of forming a color image will be described. However, the present disclosure is not limited to the image forming apparatus 1 capable of forming a color image, and each configuration described in the present exemplary embodiment can also be applied to a so-called monochrome machine capable of forming only a black-and-white image.

### Configuration of Control Unit 240

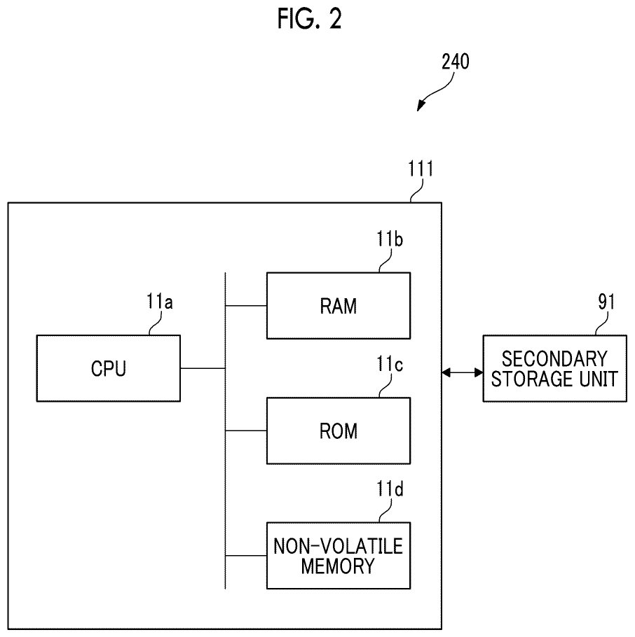

FIG. 2 is a diagram showing an example of a hardware configuration of the control unit 240. The control unit 240 is implemented by a computer.

The control unit 240 includes a computation processing unit 111 that executes digital computation processing in accordance with a program, and a secondary storage unit 91 that stores information.

The secondary storage unit 91 is implemented, for example, by an existing information storage device, such as a hard disk drive (HDD), a semiconductor memory, or a magnetic tape.

The computation processing unit 111 is provided with a CPU 11a as an example of a processor.

In addition, the computation processing unit 111 is provided with a RAM 11b that is used as a work memory or the like of the CPU 11a. The computation processing unit 111 is further provided with a ROM 11c that stores a program and the like executed by the CPU 11a.

Further, the computation processing unit 111 is provided with a non-volatile memory 11d that can retain data even in a case where power supply is interrupted.

The non-volatile memory 11d is configured, for example, as a battery-backed SRAM, a flash memory, or the like. The secondary storage unit 91 stores various kinds of information, such as a program executed by the computation processing unit 111.

In the present exemplary embodiment, the CPU 11a of the computation processing unit 111 reads the program stored in the ROM 11c or the secondary storage unit 91. The CPU 11a executes the program stored in the ROM 11c or the secondary storage unit 91. Consequently, various kinds of processing performed by the image forming apparatus 1 are executed. Various kinds of processing performed by the image forming apparatus 1 are executed by the CPU 11a.

The program executed by the CPU 11a can be provided to the image forming apparatus 1 via a recording medium.

An example of the recording medium includes a magnetic recording medium, such as a magnetic tape or a magnetic disk. Additionally, another example of the recording medium includes an optical recording medium, such as an optical disc. Further, still another example of the recording medium includes a magneto-optical recording medium. Furthermore, still another example of the recording medium includes a semiconductor memory or the like.

In addition, the program executed by the CPU 11a may be provided to the image forming apparatus 1 by using communication means such as the Internet.

With reference to FIG. 1, the image forming apparatus 1 will be further described.

The following devices are installed in each of the image forming units 1Y, 1M, 1C, and 1K.

First, a photosensitive drum 11 that rotates in a direction of an arrow A is provided. A charger 12 that charges the photosensitive drum 11 is provided around the photosensitive drum 11. An exposure device 13 that forms an electrostatic latent image on the photosensitive drum 11 is further provided. Furthermore, a developing unit 14 that develops the electrostatic latent image on the photosensitive drum 11 with a toner is provided.

In addition, each of the image forming units 1Y, 1M, 1C, and 1K is provided with a primary transfer roller 16. The primary transfer roller 16 is provided in the primary transfer unit 10. The toner image formed on the photosensitive drum 11 is transferred onto the intermediate transfer belt 15 by the primary transfer roller 16.

Further, each of the image forming units 1Y, 1M, 1C, and 1K is provided with a drum cleaner 17. The drum cleaner 17 removes residual toner and the like remaining on the photosensitive drum 11.

The intermediate transfer belt 15 circulates in a direction of an arrow B shown in FIG. 1 at a predetermined speed.

The primary transfer unit 10 includes the primary transfer roller 16 that is disposed to face the photosensitive drum 11 with the intermediate transfer belt 15 sandwiched therebetween.

In the present exemplary embodiment, the toner images on the respective photosensitive drums 11 are sequentially electrostatically attracted onto the intermediate transfer belt 15. As a result, a superimposed toner image is formed on the intermediate transfer belt 15.

The secondary transfer unit 20 includes a secondary transfer roller 22 that is disposed to face an outer peripheral surface of the intermediate transfer belt 15, and a backup roller 25.

The secondary transfer roller 22 is pressed against the backup roller 25 with the intermediate transfer belt 15 sandwiched therebetween. A voltage is applied between the secondary transfer roller 22 and the backup roller 25. In the present exemplary embodiment, the toner image on the intermediate transfer belt 15 is transferred onto the paper P conveyed to the secondary transfer unit 20.

In the present exemplary embodiment, the paper P fed out from the paper accommodating device 200 is conveyed to the secondary transfer unit 20. The toner image on the intermediate transfer belt 15 is transferred onto the paper P fed out from the paper accommodating device 200.

In the present exemplary embodiment, image data is output to the image forming apparatus 1 from an image scan device (not shown), a personal computer (PC), or the like.

Then, image processing is performed on the image data by an image processing device (not shown). Consequently, image data for four colors Y, M, C, and K is generated. The generated image data is output to the exposure device 13 provided for each of the colors Y, M, C, and K.

The exposure device 13 irradiates the photosensitive drum 11 with light in response to the input image data.

For exposure of the photosensitive drum 11 by the exposure device 13, for example, a semiconductor laser is used. Additionally, for exposure of the photosensitive drum 11 by the exposure device 13, for example, a light emitting diode (LED) is used.

In each photosensitive drum 11, a charger 12 charges the photosensitive drum 11. Thereafter, scanning exposure is performed on a surface of the photosensitive drum 11 by the exposure device 13. As a result, an electrostatic latent image is formed on the surface.

Next, toner is attached to the photosensitive drum 11 by the developing unit 14. Consequently, a toner image is formed on the photosensitive drum 11.

The toner image formed on the photosensitive drum 11 is transferred onto the intermediate transfer belt 15 by the primary transfer unit 10.

After this toner image is transferred onto a surface of the intermediate transfer belt 15, the toner image is moved to the secondary transfer unit 20 by the moving intermediate transfer belt 15.

In the secondary transfer unit 20, the secondary transfer roller 22 is pressed against the backup roller 25 via the intermediate transfer belt 15.

In the present exemplary embodiment, the paper P fed out from the paper accommodating device 200 is sandwiched between the intermediate transfer belt 15 and the secondary transfer roller 22.

Consequently, an unfixed toner image held on the intermediate transfer belt 15 is transferred onto the paper P by the secondary transfer unit 20. Thereafter, the paper P onto which the toner image has been transferred is discharged to a paper discharge section (not shown) after passing through the fixing device 60.

### Description of Paper Accommodating Device 200

The paper P is accommodated in the paper accommodating device 200 as an example of the recording medium accommodating device in a state of being loaded.

In the present exemplary embodiment, the uppermost paper P among sheets of paper P accommodated in the paper accommodating device 200 is fed out.

A paper bundle 54 is composed of a plurality of sheets of paper P accommodated in the paper accommodating device 200. The uppermost paper P among the sheets of paper P included in the paper bundle 54 is fed out.

Then, the toner image formed by the image forming section 1A is transferred onto the paper P that has been fed out, by the secondary transfer unit 20.

Further, the paper accommodating device 200 is provided with a blowing device 400 that blows gas onto the paper P accommodated in the paper accommodating device 200.

In addition, although not shown in FIG. 1, the paper accommodating device 200 is provided with an acquisition unit 300. The acquisition unit 300 acquires information regarding the paper P accommodated in the paper accommodating device 200.

In the present exemplary embodiment, the acquisition unit 300 is configured by a camera. The acquisition unit 300 acquires an image of the paper P as the information regarding the paper P to be loaded. The acquisition unit 300 is configured, for example, by a CCD or a CMOS.

Note that a target to be acquired by the acquisition unit 300 may be other than the image. The acquisition unit 300 is not limited to acquiring the image.

Examples of the acquisition unit 300 include a sensor that acquires information regarding the type of paper. Additionally, another example of the acquisition unit 300 includes a sensor that acquires information such as the color of the paper P and a degree of moisture absorption in the paper P.

In the present exemplary embodiment, gas is blown onto the loaded paper P by the blowing device 400 as an example of a gas blowing unit. In the present exemplary embodiment, gas is blown onto the paper P from a lateral side of the loaded paper P.

Consequently, in the present exemplary embodiment, the paper P is floated. In the present exemplary embodiment, the acquisition unit 300 is used to acquire the image of the floating paper P.

Then, in the present exemplary embodiment, a blowing condition of the gas onto the paper P is set based on the image.

In the present exemplary embodiment, the airflow rate of the gas to be blown onto the paper P is adjusted such that the state of the paper P shown in the image is a predetermined state.

In other words, the blowing condition of the gas is sequentially changed such that the state of the paper P shown in the image is a predetermined state.

Then, the blowing condition in a case where the state of the paper P shown in the image is a predetermined state is set as the blowing condition used during image formation.

In the present exemplary embodiment, the adjustment of the airflow rate of the gas is performed before the image formation on the paper P is started. In other words, the setting of the blowing condition of the gas is performed before image formation on the paper P is started.

Then, the adjusted airflow rate is set as the airflow rate of the gas to be blown onto the paper P in a case where the image formation is actually performed on the paper P.

In the present exemplary embodiment, the blowing device 400 is provided on both the front side and the back side of the paper bundle 54 shown in FIG. 1. In the present exemplary embodiment, gas is blown onto the paper P from both the front side and the back side.

The blowing device 400 may be provided only on one side of both the front side and the back side.

In the present exemplary embodiment, air is blown as the gas. Note that the type of gas is not particularly limited. Gas other than air may be blown onto the paper P.

In addition, the paper accommodating device 200 may be provided with a heater serving as a heat source. In this case, heated gas is blown onto the loaded paper P.

Additionally, in the present exemplary embodiment, the suction unit 100 that sucks the paper P that constitutes the paper bundle 54 is provided above the paper bundle 54.

Further, a plurality of conveyance rollers 52 that convey the paper P fed out from the paper accommodating device 200 are provided. The conveyance rollers 52 are provided downstream of the paper accommodating device 200 in a conveyance direction of the paper P.

In the present exemplary embodiment, the paper P fed out from the paper accommodating device 200 is first conveyed by a most upstream conveyance roller 52E.

The term “most upstream conveyance roller 52E” refers to a conveyance roller 52 that is positioned most upstream in the conveyance direction of the paper P among the plurality of conveyance rollers 52.

Then, this paper P is further conveyed by another conveyance roller 52 positioned downstream of the most upstream conveyance roller 52E. Consequently, the paper P is directed to the secondary transfer unit 20 and the fixing device 60.

A conveyance belt 55 is further provided downstream of the secondary transfer unit 20 in the conveyance direction of the paper P. The conveyance belt 55 conveys the paper P on which the secondary transfer has been performed to the fixing device 60.

The suction unit 100 sucks and holds the uppermost paper P, among the sheets of paper P loaded in the paper accommodating device 200.

Then, the suction unit 100 moves toward the most upstream conveyance roller 52E in a state of holding the paper P. Consequently, the paper P is delivered from the suction unit 100 to the most upstream conveyance roller 52E. As a result, the conveyance of the paper P is started by the most upstream conveyance roller 52E.

The suction unit 100 moves in a direction away from the most upstream conveyance roller 52E after delivering the paper P to the most upstream conveyance roller 52E. Accordingly, the suction unit 100 returns to an initial position.

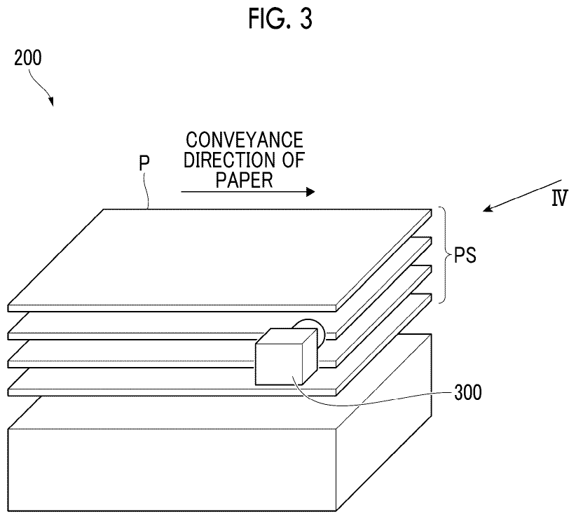

FIG. 3 is a perspective view of the paper accommodating device 200 in a case where the paper accommodating device 200 is viewed from the front side of the image forming apparatus 1.

In FIG. 3, the blowing device 400 and the suction unit 100 are not shown. In addition, FIG. 3 shows a state in which gas is being blown by the blowing device 400.

In the present exemplary embodiment, as described above and as shown in FIG. 3, the acquisition unit 300 that acquires information regarding the paper P to be loaded is provided.

The acquisition unit 300 is a camera as described above. The acquisition unit 300 acquires the image of the paper P. The acquisition unit 300 acquires an image of a leading end portion PS of the paper P, which is positioned downstream in the conveyance direction.

The acquisition unit 300 can also be regarded as an image acquisition unit that acquires the image of the paper P.

In FIG. 3, the acquisition unit 300 is provided on the front side of the paper P, but the acquisition unit 300 may be provided on the back side of the paper P. Additionally, the acquisition unit 300 may be provided on both the front side and the back side of the paper P.

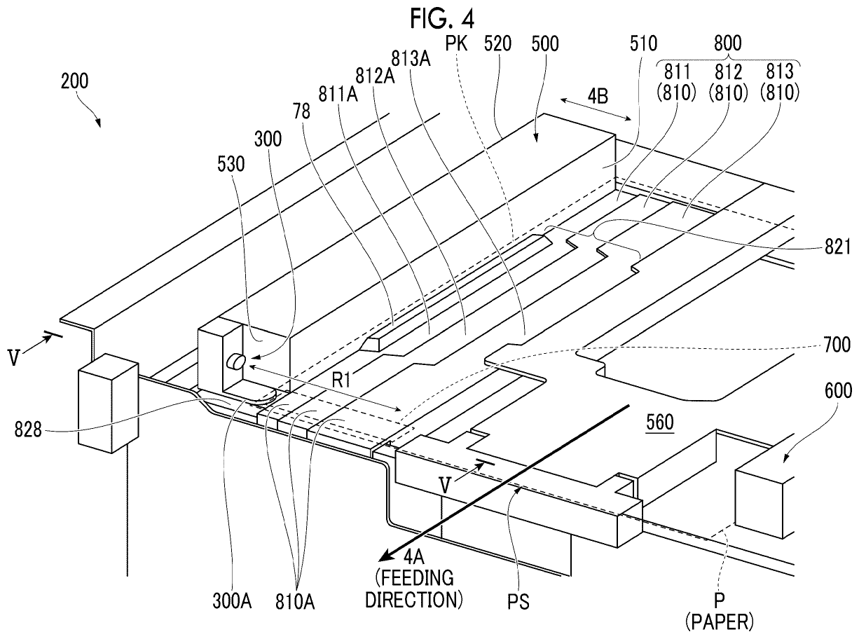

FIG. 4 is a view of the paper accommodating device 200 as viewed in a direction indicated by an arrow IV in FIG. 3.

FIG. 4 shows a state in which the paper accommodating device 200 is viewed from the downstream side in a feeding direction of the paper P and from a rear side of the image forming apparatus 1. In FIG. 4, the blowing device 400 and the suction unit 100 are also not shown.

In FIG. 4, a direction indicated by an arrow 4A is the feeding direction of the paper P.

The paper accommodating device 200 is provided with an opposing member 500 that is disposed at a position facing a side portion PK of the paper P to be loaded. The opposing member 500 is a so-called side guide.

The opposing member 500 is provided so as to extend along the feeding direction of the paper P. The paper P is formed in a rectangular shape and includes four side portions. The opposing member 500 is provided so as to extend along the side portion PK that extends along the feeding direction of the paper P among the four side portions.

A fixed member 600 is further provided on a side opposite to an installation side of the opposing member 500, with the paper P to be loaded interposed between the fixed member 600 and the opposing member 500. The fixed member 600 is also a side guide. The fixed member 600 is also provided so as to extend along the feeding direction of the paper P.

In the present exemplary embodiment, the opposing member 500 is provided to be movable, whereas the fixed member 600 is provided in a fixed state. The fixed member 600 may also be provided to be movable, similarly to the opposing member 500.

The opposing member 500 is provided to be movable in a direction indicated by an arrow 4B.

The opposing member 500 is provided to be movable in a direction intersecting the feeding direction of the paper P. More specifically, the opposing member 500 is provided to be movable in a direction orthogonal to the feeding direction.

Additionally, the opposing member 500 is provided to be movable in a width direction of the paper P.

The opposing member 500 is provided to be movable in an advancing and retracting manner with respect to the fixed member 600. Further, the opposing member 500 is provided to be movable in an advancing and retracting manner with respect to the side portion PK of the paper P to be loaded.

The opposing member 500 is formed in a rectangular parallelepiped shape.

The opposing member 500 includes an opposing surface 510 that faces the side portion PK of the paper P. In addition, the opposing member 500 includes an opposite surface 520.

The opposite surface 520 is a surface positioned on a side opposite to the opposing surface 510.

Further, the opposing member 500 includes a side surface 530. The side surface 530 is provided so as to connect the opposing surface 510 and the opposite surface 520. The side surface 530 is provided so as to extend along an advancing and retracting direction of the opposing member 500.

In the present exemplary embodiment, a position of the opposing surface 510 of the opposing member 500 in the advancing and retracting direction is different from a position of the opposite surface 520 in the advancing and retracting direction.

In the present exemplary embodiment, the opposing member 500 moves in accordance with the size of the paper P accommodated in the paper accommodating device 200.

In a case where the size of the paper P is small, the opposing member 500 moves to a side where the fixed member 600 is positioned. Additionally, in a case where the size of the paper P is large, the opposing member 500 moves to a side away from the fixed member 600. In any case, the opposing member 500 is disposed to face the side portion PK of the paper P after the movement.

The movement of the opposing member 500 may be automatically performed.

In a case where the movement of the opposing member 500 is automatically performed, the opposing member 500 is moved by using a known mechanism comprising a drive source such as a motor.

In addition, the movement of the opposing member 500 may be manually performed.

In a case where the movement of the opposing member 500 is manually performed, the operator operates the opposing member 500 to move the opposing member 500.

The acquisition unit 300 is supported by the opposing member 500. The acquisition unit 300 moves together with the opposing member 500 in accordance with advancement and retraction of the opposing member 500. The acquisition unit 300 moves along a predetermined movement path R1.

The acquisition unit 300 is provided on an opposite surface 520 side with respect to the opposing surface 510 of the opposing member 500. Additionally, the acquisition unit 300 is provided on an opposing surface 510 side with respect to the opposite surface 520. The acquisition unit 300 is provided at a location facing the side surface 530 of the opposing member 500.

In the present exemplary embodiment, a support portion 700 that supports a part of the paper P to be loaded from below is further provided. In the present exemplary embodiment, the leading end portion PS of the paper P in the conveyance direction is supported from below by the support portion 700.

The support portion 700 is provided to be movable in an up-down direction.

In addition, the support portion 700 is positioned below the movement path R1 of the acquisition unit 300. The support portion 700 is provided so as to extend along the movement path R1.

In the present exemplary embodiment, an expandable and contractible member 800 that expands and contracts in accordance with advancement and retraction of the opposing member 500 is further provided.

The expandable and contractible member 800 includes a plurality of component members 810 having mutually different positions in a height direction.

Three component members 810 are provided. Note that the number of component members 810 installed is not limited to three. The number of component members 810 installed may be two. Alternatively, the number of component members 810 installed may be four or more.

Each of the component members 810 is formed in a flat plate shape. Additionally, each of the component members 810 is provided along a horizontal direction and along the feeding direction of paper P.

Further, the plurality of component members 810 are disposed in a state of being arranged along the advancing and retracting direction of the opposing member 500. In addition, the plurality of component members 810 are disposed in a state in which the positions in the advancing and retracting direction are different from each other. Further, each of the plurality of component members 810 is provided in a state in which movement in the advancing and retracting direction is possible.

Additionally, in the present exemplary embodiment, the plurality of component members 810 are disposed such that an overlap occurs between one component member 810 that constitutes the plurality of component members 810 and another component member 810 that is positioned adjacent to the one component member 810.

In the present exemplary embodiment, among the three component members 810 provided, the component member 810 that is positioned at a location closest to the opposing member 500 is positioned at a lowest location.

In addition, among the three component members 810 provided, the component member 810 that is positioned at a location farthest from the opposing member 500 is positioned at a highest location.

Further, the component member 810 positioned between the component member 810 that is positioned at a location closest to the opposing member 500 and the component member 810 that is positioned at a location farthest from the opposing member 500 is positioned at an intermediate position in the height direction.

The component member 810 that is positioned at the intermediate position is positioned at a higher location than the above-described component member 810 that is positioned at the closest location. Additionally, the component member 810 that is positioned at the intermediate position is positioned at a lower location than the above-described component member 810 that is positioned at the farthest location.

Hereinafter, in the present specification, the component member 810 that is positioned at the closest location is referred to as a “first component member 811”. In addition, the component member 810 that is positioned at the farthest location is referred to as a “third component member 813”. Further, the component member 810 that is positioned at the intermediate position is referred to as a “second component member 812”.

The expandable and contractible member 800 is disposed at a position facing the opposing surface 510 of the opposing member 500. The expandable and contractible member 800 supports the paper P to be loaded from below.

In the present exemplary embodiment, the support portion 700 is formed by a part of the expandable and contractible member 800.

The support portion 700 is formed by a part of the expandable and contractible member 800, the part being positioned below the movement path R1.

Each of the first component member 811 to the third component member 813 includes a downstream end portion 810A positioned on the downstream side in the feeding direction of the paper P.

The support portion 700 is formed by the downstream end portion 810A of each of the first component member 811 to the third component member 813.

In the present exemplary embodiment, a central support portion 560 that supports a central portion of the paper P to be loaded from below is further provided.

Additionally, in the present exemplary embodiment, the expandable and contractible member 800 is also provided on a fixed member 600 side with respect to the central support portion 560. In FIG. 4, the expandable and contractible member 800 provided on the fixed member 600 side with respect to the central support portion 560 is not shown.

The expandable and contractible member 800 provided on the fixed member 600 side has the same configuration as the above-described expandable and contractible member 800 provided on an opposing member 500 side.

In the present exemplary embodiment, two sets of expandable and contractible members 800 are provided.

In the present exemplary embodiment, the central support portion 560 and the two sets of expandable and contractible members 800 move up and down integrally.

In the present exemplary embodiment, the central support portion 560 and the two sets of expandable and contractible members 800 move up and down by a vertical movement mechanism (not shown). The vertical movement mechanism is not particularly limited as long as the vertical movement mechanism is implemented by a known mechanism.

In the present exemplary embodiment, the central support portion 560 and the two sets of expandable and contractible members 800 move upward as the number of sheets of paper P accommodated in the paper accommodating device 200 decreases.

In the present exemplary embodiment, as the image is formed on the paper P, the number of sheets of paper P accommodated in the paper accommodating device 200 decreases.

In the present exemplary embodiment, the vertical movement mechanism operates in accordance with a decrease in the number of sheets of paper P. Consequently, the central support portion 560 and the two sets of expandable and contractible members 800 move upward.

As a result, a distance between the paper P positioned at the top and the suction unit 100 is maintained.

In the present exemplary embodiment, the length of the support portion 700 in the movement direction of the acquisition unit 300 can be changed. Consequently, in the present exemplary embodiment, the acquisition unit 300 and the support portion 700 do not interfere with each other.

In a case where the length of the support portion 700 cannot be changed, a state may occur in which the support portion 700 is positioned directly below the acquisition unit 300 due to the movement of the opposing member 500 toward the fixed member 600 side.

In this state, in a case where the support portion 700 moves upward, the acquisition unit 300 and the support portion 700 may interfere with each other.

On the other hand, in the present exemplary embodiment, the length of the support portion 700 in the movement direction of the acquisition unit 300 can be changed.

In the present exemplary embodiment, the length of the support portion 700 is changed by expansion and contraction of the expandable and contractible member 800 that constitutes the support portion 700.

In the present exemplary embodiment, in a case where the opposing member 500 moves toward the fixed member 600 side, the expandable and contractible member 800 is pressed by the opposing member 500. Consequently, the expandable and contractible member 800 contracts. Accordingly, the length of the support portion 700 in the movement direction of the opposing member 500 becomes shorter.

In a configuration in which the length of the support portion 700 becomes shorter, it is possible to avoid a situation in which the support portion 700 enters directly below the acquisition unit 300. In this case, even in a case where the support portion 700 moves upward, interference between the acquisition unit 300 and the support portion 700 can be avoided.

In a configuration in which the acquisition unit 300 and the support portion 700 interfere with each other, a malfunction such as damage to the acquisition unit 300 may occur. In the present exemplary embodiment, the occurrence of the malfunction such as damage to the acquisition unit 300 can be suppressed.

In the present exemplary embodiment, a supporting portion 828 that supports a downstream end portion 810A side of the expandable and contractible member 800 from below is provided. The supporting portion 828 is provided along the movement direction of the opposing member 500.

Each of the first component member 811 to the third component member 813 that constitute the expandable and contractible member 800 is supported from below by the supporting portion 828.

In the present exemplary embodiment, the supporting portion 828 is configured not to reach the acquisition unit 300.

In the present exemplary embodiment, the supporting portion 828 also moves up and down. In the present exemplary embodiment, in a state in which the central support portion 560 and the two sets of expandable and contractible members 800 are moved to the uppermost position, the supporting portion 828 is configured to be positioned below the acquisition unit 300.

The supporting portion 828 is positioned below the acquisition unit 300, but in the present exemplary embodiment, the supporting portion 828 and the acquisition unit 300 do not interfere with each other.

In the present exemplary embodiment, in a state in which the central support portion 560 and the two sets of expandable and contractible members 800 are moved to the uppermost position, the supporting portion 828 is positioned below a lower end portion 300A of the acquisition unit 300.

On the other hand, the support portion 700 is positioned above the lower end portion 300A of the acquisition unit 300.

Even in this case, in the present exemplary embodiment, the acquisition unit 300 and the support portion 700 do not interfere with each other. In the present exemplary embodiment, as described above, the support portion 700 does not enter directly below the acquisition unit 300. In this case, the acquisition unit 300 and the support portion 700 do not interfere with each other.

In the present exemplary embodiment, protruding portions 78 that protrude upward are provided on at least some of the component members 810, among the first component member 811 to the third component member 813, which are the component members 810 that constitute the expandable and contractible member 800.

Specifically, in the present exemplary embodiment, the protruding portion 78 that protrudes upward is provided on the first component member 811 that is positioned at a location closest to the opposing member 500.

The first component member 811 is the component member 810 that is positioned at the lowest location. As described above, the first component member 811 that is positioned at the lowest location is positioned at the location closest to the opposing surface 510 of the opposing member 500.

In the present exemplary embodiment, the protruding portion 78 is provided on the first component member 811 that is positioned at the lowest location and that is positioned at the location closest to the opposing surface 510. The protruding portion 78 protrudes upward from an upper surface 811A of the first component member 811.

As in the present exemplary embodiment, in a case where the positions of the component members 810 in the height direction are different from each other, the position of a part of the paper P in the height direction and the position of another part of the paper P in the height direction are different from each other.

In this case, unevenness is likely to occur on the upper surface of the paper bundle 54 (refer to FIG. 1) supported from below by the plurality of component members 810.

On the other hand, in a case where the protruding portion 78 is provided as in the present exemplary embodiment, unevenness is less likely to occur on the upper surface of the paper bundle 54.

The protruding portion 78 is not limited to being provided on the component member 810 that is positioned at the lowest location, and may be provided on other component members 810.

The protruding portion 78 may be provided on an upper surface 812A of the second component member 812 or an upper surface 813A of the third component member 813. That is, the protruding portion 78 may be provided on all the three component members 810.

In this case, it is preferable that the protrusion amount of the protruding portion 78 provided on the second component member 812 is smaller than, for example, the protrusion amount of the protruding portion 78 provided on the first component member 811. In addition, it is preferable that the protrusion amount of the protruding portion 78 provided on the third component member 813 is smaller than, for example, the protrusion amount of the protruding portion 78 provided on the second component member 812.

In FIG. 4, a configuration is shown in which the first component member 811 that is positioned at the lowest location is provided on the opposing surface 510 side. However, the present disclosure is not limited to the above configuration, and the first component member 811 that is positioned at the lowest location may be provided on a central support portion 560 side. In this case, the third component member 813 that is positioned at the highest location is provided on the opposing member 500 side.

In a case where the first component member 811 that is positioned at the lowest location is provided on the central support portion 560 side, it is preferable that the protruding portion 78 is provided, for example, at least on the upper surface 811A of the first component member 811 that is positioned on the central support portion 560 side.

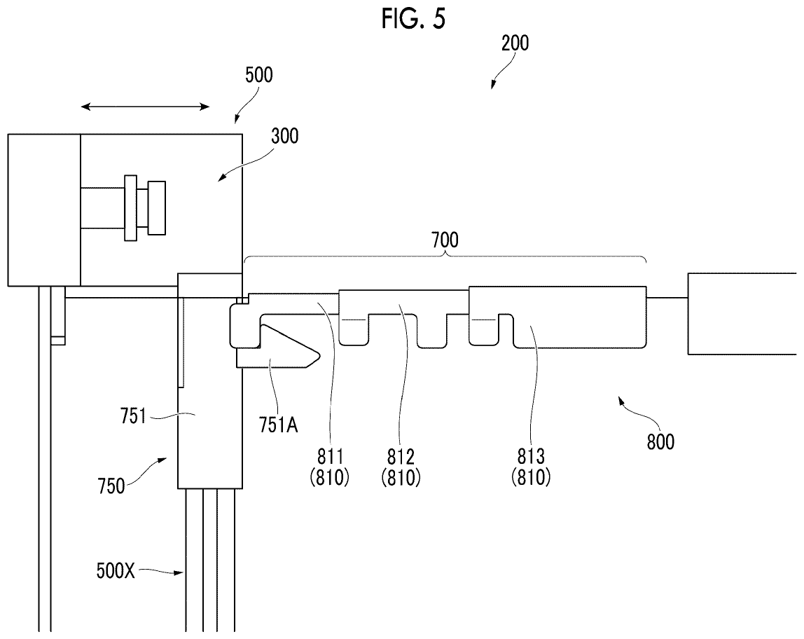

FIG. 5 is a cross-sectional view of the paper accommodating device 200 taken along line V-V of FIG. 4.

In the present exemplary embodiment, a change mechanism 750 that changes the length of the support portion 700 is further provided. In the present exemplary embodiment, the support portion 700 extends by means of the change mechanism 750, and the support portion 700 becomes longer.

The change mechanism 750 changes the length of the support portion 700 by using a force from the moving opposing member 500.

The change mechanism 750 changes the length of the support portion 700 by using a force from the opposing member 500 that moves in a direction away from the fixed member 600. In FIG. 5, the fixed member 600 is not shown.

A movement member 751 is provided as a member that constitutes the change mechanism 750.

The movement member 751 is attached to the opposing member 500. The movement member 751 moves together with the opposing member 500.

The movement member 751 is provided so as to be hooked onto the expandable and contractible member 800. Specifically, the movement member 751 is provided so as to be hooked onto the first component member 811 of the expandable and contractible member 800. The movement member 751 is provided with a hooking portion 751A that hooks onto the first component member 811.

Additionally, the movement member 751 is provided in a state of being movable up and down. The opposing member 500 is provided with a guide portion 500X that guides the movement member 751. The movement member 751 that moves up and down is guided by the guide portion 500X.

In the present exemplary embodiment, the movement member 751 moves up and down in conjunction with the expandable and contractible member 800 that moves up and down, and the like.

In the present exemplary embodiment, in a case where the expandable and contractible member 800 descends, the hooking portion 751A is pressed by the first component member 811 from above. Consequently, the movement member 751 descends.

Further, in the present exemplary embodiment, in a case where the expandable and contractible member 800 rises, the movement member 751 is pressed from below.

The movement member 751 is pressed from below by the supporting portion 828 shown in FIG. 4, which rises together with the expandable and contractible member 800. Consequently, the movement member 751 rises.

In the present exemplary embodiment, in a case where the opposing member 500 shown in FIG. 5 moves in a direction away from the fixed member 600, the movement member 751 also moves in the direction away from the fixed member 600. Accordingly, the first component member 811 that constitutes the expandable and contractible member 800 moves in the direction away from the fixed member 600.

In association with this, the second component member 812 and the third component member 813 also move in the direction away from the fixed member 600. Consequently, the expandable and contractible member 800 expands. As a result, the support portion 700 also expands.

The first component member 811 and the second component member 812 are configured to hook onto each other. In addition, the second component member 812 and the third component member 813 are also configured to hook onto each other.

Consequently, in the present exemplary embodiment, the second component member 812 also moves in the direction away from the fixed member 600 in accordance with the above-described movement of the first component member 811 in the direction away from the fixed member 600. Further, the third component member 813 also moves in the direction away from the fixed member 600 in accordance with the movement of the second component member 812 in the direction away from the fixed member 600.

As a result, the support portion 700 expands.

In a case where the opposing member 500 moves toward the fixed member 600 side, the expandable and contractible member 800 is pressed by the opposing member 500. Accordingly, the expandable and contractible member 800 contracts, and the support portion 700 becomes shorter.

In the present exemplary embodiment, the support portion 700 does not reach the opposite surface 520 side beyond the opposing surface 510 of the opposing member 500 shown in FIG. 4.

In the present exemplary embodiment, a linkage portion 821 that interlocks with the support portion 700 is provided. The linkage portion 821 is formed by a part of the expandable and contractible member 800.

The support portion 700 is formed by a part of the expandable and contractible member 800. Additionally, the linkage portion 821 is formed by another part of the expandable and contractible member 800.

The linkage portion 821 is positioned at a location facing the opposing surface 510. The linkage portion 821 also supports a part of the paper P to be loaded from below.

In the present exemplary embodiment, the linkage portion 821 abuts against the opposing surface 510. As a result, the support portion 700 that interlocks with the linkage portion 821 does not reach the opposite surface 520 side beyond the opposing surface 510.

In the present exemplary embodiment, the protruding portion 78 described above is provided on an upper surface of the linkage portion 821.

The protruding portion 78 may be provided on an upper surface of the support portion 700. In addition, the protruding portion 78 may be provided on both the upper surface of the linkage portion 821 and the upper surface of the support portion 700.

In a case where the protruding portion 78 is provided on the upper surface of the support portion 700, as in the above, it is preferable that the protruding portion 78 is provided, for example, at least on the upper surface 811A of the first component member 811 that is positioned at the lowest location.

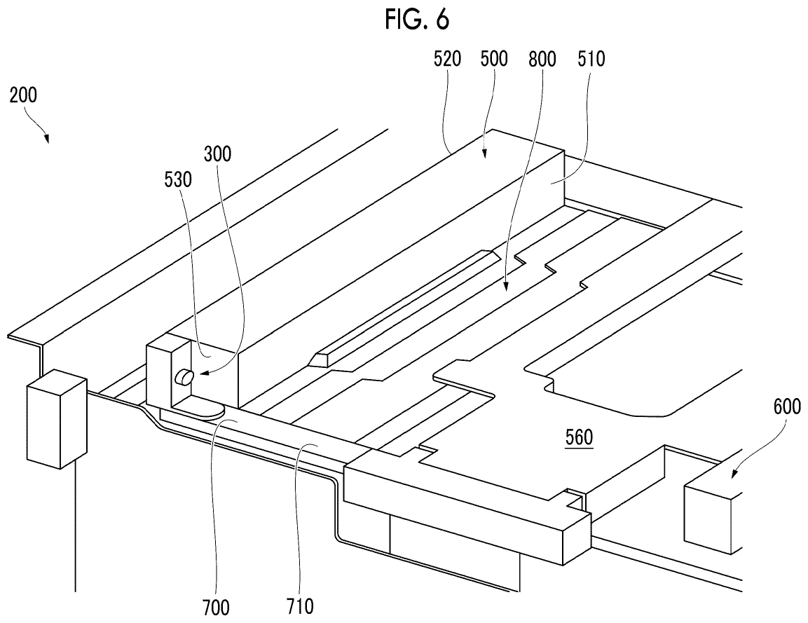

FIG. 6 is a view showing a comparative example of the paper accommodating device 200.

In this comparative example as well, the support portion 700 is provided.

The support portion 700 is also provided to be movable in the up-down direction. In this comparative example as well, the support portion 700, the two sets of expandable and contractible members 800, and the central support portion 560 rise in accordance with a decrease in the number of sheets of paper P. The support portion 700 supports the paper P (not shown) from below.

In this comparative example, the length of the support portion 700 in the movement direction of the acquisition unit 300 cannot be changed. In the comparative example, a component member 710 for forming the support portion 700 is provided separately from the expandable and contractible member 800.

In the comparative example, as in the above, the length of the expandable and contractible member 800 in the movement direction of the acquisition unit 300 can be changed. On the other hand, the support portion 700 is formed by a single component member 710 that cannot expand and contract. In this case, the length of the support portion 700 in the movement direction of the acquisition unit 300 cannot be changed.

In the comparative example, the support portion 700 is configured to reach the opposite surface 520 side beyond the opposing surface 510 of the opposing member 500.

In the comparative example, in a case where the opposing member 500 moves to the fixed member 600 side, a part of the support portion 700 reaches the opposite surface 520 side beyond the opposing surface 510 of the opposing member 500. In this case, the support portion 700 is positioned directly below the acquisition unit 300.

In a case where the support portion 700 rises in this state, the support portion 700 and the acquisition unit 300 may interfere with each other.

On the other hand, in the configuration of the present exemplary embodiment described above, this interference does not occur.

### Others

In the above description, a configuration has been described in which the expandable and contractible member 800 including the first component member 811 to the third component member 813 is provided, but other configurations may also be employed. Even in a case where other configurations are employed, interference between the support portion 700 and the acquisition unit 300 can be avoided.

For example, a configuration may be employed in which only a single component member 810 is provided, such as installing only the first component member 811 among the first component member 811 to the third component member 813.

A configuration may also be employed in which only a single component member 810 is provided between the opposing member 500 and the central support portion 560. Additionally, a configuration may also be employed in which only a single component member 810 is provided between the fixed member 600 and the central support portion 560.

In other words, a configuration may be employed in which only a single component member 810 is provided instead of the expandable and contractible member 800 at each of the locations where the two sets of expandable and contractible members 800 are positioned.

In addition, a configuration may also be employed in which a plurality of component members 810 are provided instead of the expandable and contractible member 800 at each of the locations where the two sets of expandable and contractible members 800 are positioned, and the plurality of component members 810 are coupled and fixed to each other.

It is not required to provide a member having an expansion and contraction function between the opposing member 500 and the central support portion 560.

A single component member 810 may be provided between the opposing member 500 and the central support portion 560, or a plurality of component members 810 that are fixed to each other and do not move relative to each other may be provided.

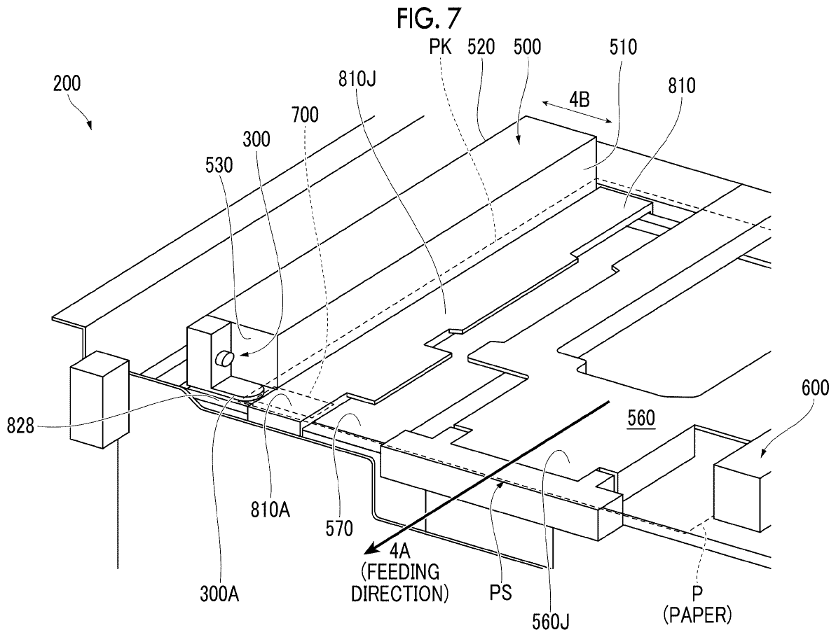

Hereinafter, with reference to FIG. 7, a configuration example will be described in which a member having no expansion and contraction function is provided between the opposing member 500 and the central support portion 560. In FIG. 7, as an example, a configuration example will be described in which a single component member 810 is provided.

FIG. 7 is a view showing another configuration example of the paper accommodating device 200, in which a single component member 810 is provided.

In this configuration example, a configuration is employed in which only a single component member 810 is provided. Although not shown, only a single component member 810 is provided on the fixed member 600 side in the same manner.

In this configuration example, in the height direction, the position of an upper surface 810J of the component member 810 and the position of an upper surface 560J of the central support portion 560 coincide with each other. In this configuration example, the protruding portion 78 shown in FIG. 4 is not provided on the component member 810.

The presence or absence of the protruding portion 78 need only be decided according to the position of the upper surface 810J of the component member 810 in the height direction.

As in the configuration example shown in FIG. 7, in a case where the position of the upper surface 810J of the component member 810 and the position of the upper surface 560J of the central support portion 560 coincide with each other, the protruding portion 78 can be omitted.

In this configuration example as well, as in the above, the component member 810 is positioned at a location facing the opposing surface 510 of the opposing member 500. Therefore, in this configuration example as well, the component member 810 does not reach the opposite surface 520 beyond the opposing surface 510.

Additionally, in this configuration example, the support portion 700 is also formed by the downstream end portion 810A of the component member 810. In this configuration example as well, the support portion 700 does not reach the opposite surface 520 side beyond the opposing surface 510 of the opposing member 500.

In this configuration example, the support portion 700 is configured such that the position of the support portion 700 in the movement direction of the acquisition unit 300 is changeable. Consequently, the support portion 700 does not reach the opposite surface 520 side beyond the opposing surface 510 of the opposing member 500.

Even in a case where the opposing member 500 moves to the central support portion 560 side, the support portion 700 also moves to the central support portion 560 side. Accordingly, the support portion 700 does not reach the opposite surface 520 side beyond the opposing surface 510 of the opposing member 500.

As a result, in this configuration example as well, it is possible to avoid a situation in which the support portion 700 enters directly below the acquisition unit 300. In this case, as in the above, even in a case where the support portion 700 moves upward, the acquisition unit 300 and the support portion 700 do not interfere with each other.

In this configuration example, the central portion of the paper P in the width direction is supported by the central support portion 560. In addition, the end portion of the paper P in the width direction is supported from below by the component member 810.

Here, the “width direction of the paper P” is synonymous with a direction orthogonal to the feeding direction of the paper P.

Although not shown in FIG. 7, as in the above, the movement member 751 shown in FIG. 5 is also provided. In this configuration example shown in FIG. 7 as well, the component member 810 moves in conjunction with the opposing member 500.

In the configuration example shown in FIG. 7, a gap 570 is generated between the component member 810 and the central support portion 560.

In a case where the opposing member 500 is disposed in a state of being separated from the central support portion 560, the gap 570 is generated between the component member 810 and the central support portion 560.

In this case, the paper P to be loaded is disposed so as to straddle the gap 570.

Even in a case where the gap 570 is generated between the component member 810 and the central support portion 560, the central portion and the end portion of the paper P in the width direction are supported from below. In this case, a situation in which the paper P falls downward does not occur.

In FIG. 7, a configuration example is shown in which the protruding portion 78 is not provided. However, the present disclosure is not limited to the above configuration example, and the protruding portion 78 may be provided on the component member 810.

For example, in a case where the upper surface 810J of the component member 810 is positioned below the position shown in FIG. 7, it is preferable to provide the protruding portion 78.

Additionally, as described above, a plurality of component members 810 in a case of being fixed to each other may also be provided between the opposing member 500 and the central support portion 560.

In this case as well, the support portion 700 moves to the central support portion 560 side even in a case where the opposing member 500 moves to the central support portion 560 side. Consequently, the support portion 700 does not reach the opposite surface 520 side beyond the opposing surface 510 of the opposing member 500.

Further, the gap 570 may be generated even in a case where the plurality of component members 810 in a state of being fixed to each other are provided between the opposing member 500 and the central support portion 560. However, in this case as well, the end portion and the central portion of the paper P in the width direction are supported from below, and the paper P does not fall downward.

### Supplementary Notes

(((1)))

A recording medium accommodating device comprising:
an opposing member that is provided to be movable in an advancing and retracting manner with respect to a side portion of a recording medium to be loaded and that is disposed at a position facing the side portion;
an acquisition unit that acquires information regarding the recording medium to be loaded, the acquisition unit being supported by the opposing member and moving in accordance with advancement and retraction of the opposing member; and
a support portion that is disposed below a movement path of the acquisition unit and that is provided to be movable in an up-down direction and supports a part of the recording medium to be loaded from below,
wherein the support portion is configured such that a length of the support portion in a movement direction of the acquisition unit is changeable.
   (((2)))

The recording medium accommodating device according to (((1))), further comprising:
a change mechanism that changes the length of the support portion.
   (((3)))

The recording medium accommodating device according to (((2))),
wherein the change mechanism changes the length of the support portion by using a force from the moving opposing member.
   (((4)))

The recording medium accommodating device according to any one of (((1))) to (((3))),
wherein the opposing member includes an opposing surface that faces the side portion of the recording medium, and an opposite surface that is positioned on a side opposite to the opposing surface and that has a position different from a position of the opposing surface in an advancing and retracting direction of the opposing member,
the acquisition unit is provided on an opposite surface side with respect to the opposing surface of the opposing member, and
the support portion is configured not to reach the opposite surface side beyond the opposing surface of the opposing member.
   (((5)))

The recording medium accommodating device according to (((4))), further comprising:
a linkage portion that interlocks with the support portion, the linkage portion being positioned at a location facing the opposing surface,
wherein the support portion is configured not to reach the opposite surface side in a case where the linkage portion abuts against the opposing surface.
   (((6)))

The recording medium accommodating device according to (((5))),
wherein the linkage portion supports a part of the recording medium to be loaded from below, and
a protruding portion that protrudes upward is provided on at least one of an upper surface of the support portion or an upper surface of the linkage portion.
   (((7)))

The recording medium accommodating device according to (((1))),
wherein the opposing member includes an opposing surface that faces the side portion of the recording medium, and an opposite surface that is positioned on a side opposite to the opposing surface and that has a position different from a position of the opposing surface in an advancing and retracting direction of the opposing member,
an expandable and contractible member that includes a plurality of members having mutually different positions in a height direction, that is disposed at a position facing the opposing surface of the opposing member, that supports the recording medium to be loaded from below, and that expands and contracts in accordance with advancement and retraction of the opposing member is further provided, and
the support portion is formed by a part of the expandable and contractible member, the part of the expandable and contractible member being positioned below the movement path.
   (((8)))

The recording medium accommodating device according to (((7))),
wherein protruding portions that protrude upward are provided on at least some of the plurality of members that constitute the expandable and contractible member.
   (((9))

The recording medium accommodating device according to (((8))),
wherein a protruding portion that protrudes upward is provided on a member that is positioned at a lowest location among the plurality of members that constitute the expandable and contractible member.
   (((10)))

The recording medium accommodating device according to (((9))),
wherein the member that is positioned at the lowest location is a member that is positioned at a location closest to the opposing surface among the plurality of members, and
the protruding portion is provided on the member that is positioned at the lowest location and that is positioned at the location closest to the opposing surface.
   (((11)))

A recording medium accommodating device comprising:
an opposing member that is provided to be movable in an advancing and retracting manner with respect to a side portion of a recording medium to be loaded and that is disposed at a position facing the side portion;
an acquisition unit that acquires information regarding the recording medium to be loaded, the acquisition unit being supported by the opposing member and moving in accordance with advancement and retraction of the opposing member; and
a support portion that is disposed below a movement path of the acquisition unit and that is provided to be movable in an up-down direction and supports a part of the recording medium to be loaded from below,
wherein the support portion is configured such that a position of the support portion in a movement direction of the acquisition unit is changeable.
   (((12)))

The recording medium accommodating device according to (((11))),
wherein the opposing member includes an opposing surface that faces the side portion of the recording medium, and an opposite surface that is positioned on a side opposite to the opposing surface and that has a position different from a position of the opposing surface in an advancing and retracting direction of the opposing member,
the acquisition unit is provided on an opposite surface side with respect to the opposing surface of the opposing member, and
the support portion is configured not to reach the opposite surface side beyond the opposing surface of the opposing member.
   (((13)))

An image forming apparatus comprising:
a recording medium accommodating device that accommodates a recording medium; and
an image forming section that forms an image on the recording medium fed out from the recording medium accommodating device,
wherein the recording medium accommodating device is configured by the recording medium accommodating device according to any one of (((1))) to (((12))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording medium accommodating device comprising:
an opposing member that is provided to be movable in an advancing and retracting manner with respect to a side portion of a recording medium to be loaded and that is disposed at a position facing the side portion;
an acquisition unit that acquires information regarding the recording medium to be loaded, the acquisition unit being supported by the opposing member and moving in accordance with advancement and retraction of the opposing member; and
a support portion that is disposed below a movement path of the acquisition unit and that is provided to be movable in an up-down direction and supports a part of the recording medium to be loaded from below,
wherein the support portion is configured such that a length of the support portion in a movement direction of the acquisition unit is changeable.

2. The recording medium accommodating device according to claim 1, further comprising:
a change mechanism that changes the length of the support portion.

3. The recording medium accommodating device according to claim 2,
wherein the change mechanism changes the length of the support portion by using a force from the moving opposing member.

4. The recording medium accommodating device according to claim 1,
wherein the opposing member includes an opposing surface that faces the side portion of the recording medium, and an opposite surface that is positioned on a side opposite to the opposing surface and that has a position different from a position of the opposing surface in an advancing and retracting direction of the opposing member,
the acquisition unit is provided on an opposite surface side with respect to the opposing surface of the opposing member, and
the support portion is configured not to reach the opposite surface side beyond the opposing surface of the opposing member.

5. The recording medium accommodating device according to claim 4, further comprising:
a linkage portion that interlocks with the support portion, the linkage portion being positioned at a location facing the opposing surface,
wherein the support portion is configured not to reach the opposite surface side in a case where the linkage portion abuts against the opposing surface.

6. The recording medium accommodating device according to claim 5,
wherein the linkage portion supports a part of the recording medium to be loaded from below, and
a protruding portion that protrudes upward is provided on at least one of an upper surface of the support portion or an upper surface of the linkage portion.

7. The recording medium accommodating device according to claim 1,
wherein the opposing member includes an opposing surface that faces the side portion of the recording medium, and an opposite surface that is positioned on a side opposite to the opposing surface and that has a position different from a position of the opposing surface in an advancing and retracting direction of the opposing member,
an expandable and contractible member that includes a plurality of members having mutually different positions in a height direction, that is disposed at a position facing the opposing surface of the opposing member, that supports the recording medium to be loaded from below, and that expands and contracts in accordance with advancement and retraction of the opposing member is further provided, and
the support portion is formed by a part of the expandable and contractible member, the part of the expandable and contractible member being positioned below the movement path.

8. The recording medium accommodating device according to claim 7,
wherein protruding portions that protrude upward are provided on at least some of the plurality of members that constitute the expandable and contractible member.

9. The recording medium accommodating device according to claim 8,
wherein a protruding portion that protrudes upward is provided on a member that is positioned at a lowest location among the plurality of members that constitute the expandable and contractible member.

10. The recording medium accommodating device according to claim 9,
wherein the member that is positioned at the lowest location is a member that is positioned at a location closest to the opposing surface among the plurality of members, and
the protruding portion is provided on the member that is positioned at the lowest location and that is positioned at the location closest to the opposing surface.

11. A recording medium accommodating device comprising:
an opposing member that is provided to be movable in an advancing and retracting manner with respect to a side portion of a recording medium to be loaded and that is disposed at a position facing the side portion;
an acquisition unit that acquires information regarding the recording medium to be loaded, the acquisition unit being supported by the opposing member and moving in accordance with advancement and retraction of the opposing member; and
a support portion that is disposed below a movement path of the acquisition unit and that is provided to be movable in an up-down direction and supports a part of the recording medium to be loaded from below,
wherein the support portion is configured such that a position of the support portion in a movement direction of the acquisition unit is changeable.

12. The recording medium accommodating device according to claim 11,
wherein the opposing member includes an opposing surface that faces the side portion of the recording medium, and an opposite surface that is positioned on a side opposite to the opposing surface and that has a position different from a position of the opposing surface in an advancing and retracting direction of the opposing member,
the acquisition unit is provided on an opposite surface side with respect to the opposing surface of the opposing member, and
the support portion is configured not to reach the opposite surface side beyond the opposing surface of the opposing member.

13. An image forming apparatus comprising:
a recording medium accommodating device that accommodates a recording medium; and
an image forming section that forms an image on the recording medium fed out from the recording medium accommodating device,
wherein the recording medium accommodating device is configured by the recording medium accommodating device according to claim 1.

14. An image forming apparatus comprising:
a recording medium accommodating device that accommodates a recording medium; and
an image forming section that forms an image on the recording medium fed out from the recording medium accommodating device,
wherein the recording medium accommodating device is configured by the recording medium accommodating device according to claim 2.

15. An image forming apparatus comprising:
a recording medium accommodating device that accommodates a recording medium; and
an image forming section that forms an image on the recording medium fed out from the recording medium accommodating device,
wherein the recording medium accommodating device is configured by the recording medium accommodating device according to claim 3.

16. An image forming apparatus comprising:
a recording medium accommodating device that accommodates a recording medium; and
an image forming section that forms an image on the recording medium fed out from the recording medium accommodating device,
wherein the recording medium accommodating device is configured by the recording medium accommodating device according to claim 4.

17. An image forming apparatus comprising:
a recording medium accommodating device that accommodates a recording medium; and
an image forming section that forms an image on the recording medium fed out from the recording medium accommodating device,
wherein the recording medium accommodating device is configured by the recording medium accommodating device according to claim 5.

18. An image forming apparatus comprising:
a recording medium accommodating device that accommodates a recording medium; and
an image forming section that forms an image on the recording medium fed out from the recording medium accommodating device,
wherein the recording medium accommodating device is configured by the recording medium accommodating device according to claim 6.

19. An image forming apparatus comprising:
a recording medium accommodating device that accommodates a recording medium; and
an image forming section that forms an image on the recording medium fed out from the recording medium accommodating device,
wherein the recording medium accommodating device is configured by the recording medium accommodating device according to claim 7.

20. An image forming apparatus comprising:
a recording medium accommodating device that accommodates a recording medium; and
an image forming section that forms an image on the recording medium fed out from the recording medium accommodating device,
wherein the recording medium accommodating device is configured by the recording medium accommodating device according to claim 8.
